(19) United States
(12) Patent Application Publication
(10) Pub. No.: US 2016/0098637 A1
(43) Pub. Date: Apr. 7, 2016

(54) Automated Data Analytics for Work Machines

(71) Applicant: Caterpillar Inc., Peoria, IL (US)

(72) Inventors: Benjamin Hodel, Dunlap, IL (US); Nathan J. Wieland, Eureka, IL (US)

(73) Assignee: CATERPILLAR INC., Peoria, IL (US)

(21) Appl. No.: 14/505,779

(22) Filed: Oct. 3, 2014

(51) Int. Cl. G06N 5/04; G06N 99/00

(52) U.S. Cl. CPC G06N 5/04; G06N 99/005

(57) ABSTRACT

Systems and methods for aggregating classifications of predictive operations of a machine may include one or more sensors in communication with a processor. Such systems and methods may be implemented to receive on-board machine time series data, process the data, segment the processed data, resolve the segmented data, and characterize the segmented data. Additionally, such systems and methods may be implemented to determine profile percentage breakdowns of a machine, performance reports, and productivity reports, and inform composite work cycles.

### TECHNICAL FIELD

The present disclosure relates generally to construction machines and, more particularly, to a system that aggregates classifications of predictive operations of such machines.

### BACKGROUND

Valuable insight may be gained from knowing how a machine is being operated in the field. Machines known in the earth-moving and agricultural industries such as, for example, loaders, electric rope shovels, motor graders, mining equipment, agricultural equipment and track-type tractors perform various operations in the field, which may be acquired as periodically-sampled time series data of on-board machine signals. In particular, it would be useful, for manufacturers and operators of such machines, to know specific events and movements of the machine by distinct operations for later aggregation and evaluation. However, segmenting the raw, on-board machine time series data to predict specific machine operations tends to be difficult and may be unreliable. Without a reliable technique to segment the raw time series data into specific machine operations, it is not possible to resolve multiple machine operations into higher-level groupings of machine cycles or applications for the purpose of aggregating into machine application profile percentages. Moreover, it is also not possible to aggregate the many hours of related machine parameters by specific machine operation to get an estimate of field severity and performance characterization, both of which would provide valuable insight.

U.S. Patent Application Publication No. 2013/0204808 (the '808 publication) discloses systems and methods for fault prediction of monitored assets such as turbines. While the '808 publication detects on-site monitoring data in the form of time series data to predict faults of the turbine, it fails to segment such time series data in order to predict specific machine operations for resolving into higher-level groupings of machine cycles or applications for later aggregation. In light of this, the '808 publication also fails to teach aggregating machine cycles or application into percentage breakdowns of the machine profile or aggregating the many hours of related machine parameters by specific machine operation, and as such, cannot teach processing to get an estimate of field severity and performance characterization of machine operations.

### SUMMARY

In accordance with an aspect of the disclosure, a system is provided for aggregating classifications of predictive operations of a machine. The system may include one or more sensors in communication with a processor. The system may also include a pre-processing module associated with the one or more sensors and executed by the processor. The pre-processing module may receive on-board machine time series data from the one or more sensors and executed by the processor. The system may include an operation classifier module associated with the pre-processing module and executed by the processor. The operation classifier module may receive processed data from the pre-processing module. The system may include an application resolver module associated with the operation classifier module. The application resolver module may receive machine operation predictions from the operation classifier module and executed by the processor. The system may include a characterizer module associated with the operation classifier module and executed by the processor. The characterizer module may receive machine operation predictions from the operation classifier module. The system may include an application profile module associated with resolver module and executed by the processor. The application profile module may receive one of cycle data and application data from the application resolver module. The system may include a reports module associated with the characterizer module and the resolver module and executed by the processor. The reports module may receive severity and performance data from the characterizer module and receiving the one of cycle data and application data from the resolver module. The system may include a composite work cycle module associated with the characterizer module and executed by the processor. The composite work cycle module may receive the severity and performance data from the characterizer module.

In accordance with another aspect of the disclosure, a method for aggregating classifications of predictive operations of a machine is provided. The method may include receiving, from one or more sensors of the machine, on-board machine time series data. The method may include processing the on-board machine time series data into processed data using a computer processor. The method may include segmenting the processed data into machine operation predictions using the computer processor. The method may include resolving the machine operation predictions into one of cycle data and application data using the computer processor. The method may include characterizing the machine operation predictions into severity measures and performance measures using the computer processor. The method may include determining profile percentage breakdowns of what the machine was doing using the computer processor. The method may include determining performance reports and productivity reports using the computer processor. The method may include informing a composite work cycle using the computer processor.

In accordance with yet another aspect of the disclosure, a non-transitory, computer readable medium having thereon computer-executable instructions for aggregating classifications of predictive operations of a machine is provided. The instructions may include instructions for receiving, from one or more sensors of the machine, onboard-machine time series data. The instructions may include instructions for processing the on-board machine time series data into processed data. The instructions may include instructions for segmenting the processed data into machine operation predictions. The instructions may include instructions for resolving the machine operation predictions into one of cycle data and application data. The instructions may include instructions for characterizing the machine operation predictions into severity measures and performance measures. The instructions may include instructions for determining profile percentage breakdowns of what the machine was doing. The instructions may include instructions for determining performance reports and productivity reports. The instructions may include instructions for informing a composite work cycle.

Other aspects and features of the disclosed systems and methods will be appreciated from reading the attached detailed description in conjunction with the included drawing figures. Moreover, selected aspects and features of one example embodiment may be combined with various selected aspects and features of other example embodiments.

### BRIEF DESCRIPTION OF THE DRAWINGS

For further understanding of the disclosed concepts and embodiments, reference may be made to the following detailed description, read in connection with the drawings, wherein like elements are numbered alike, and in which:

FIG. 1 is a schematic diagram of an exemplary system for aggregating classifications of predictive operations of a machine in accordance with the teachings of this disclosure;

FIG. 2 is a flowchart illustrating a sample sequence of steps which may be practiced in accordance with the teaching of this disclosure; and

FIG. 3 is a schematic diagram for an example computer that may execute instructions for providing the example systems and methods of the present disclosure.

It is to be noted that the appended drawings illustrate only typical embodiments and are therefore not to be considered limiting with respect to the scope of the disclosure or claims. Rather, the concepts of the present disclosure may apply within other equally effective embodiments. Moreover, the drawings are not necessarily to scale, emphasis generally being placed upon illustrating the principles of certain embodiments.

### DETAILED DESCRIPTION

The present disclosure provides systems and methods for aggregating classifications of predictive operations of a machine. Such systems and methods may correlate and translate raw, onboard time series data into machine operations based upon different data sets to provide estimates of field severity and performance characterization, to resolve sequences of the machine operations into higher-level events, and to provide percentage breakdowns of the higher-level events.

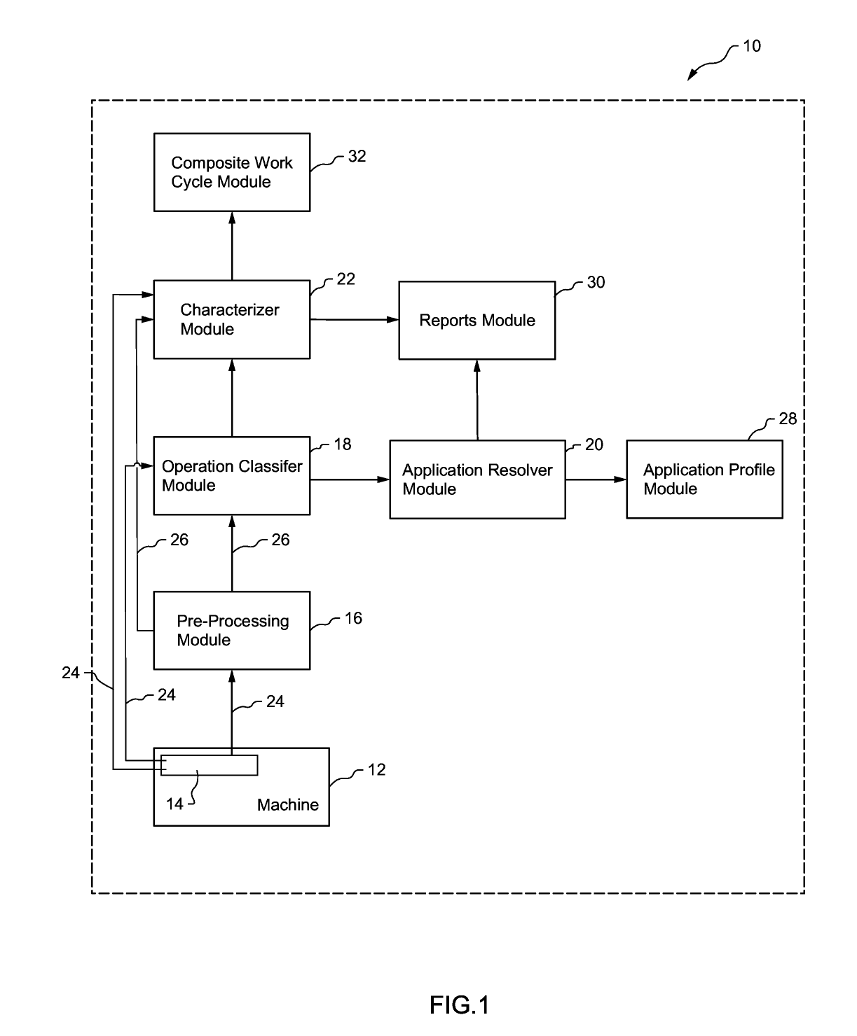

Turning now to the drawings, and with specific reference to FIG. 1, an exemplary system for aggregating classifications of predictive operations of a machine is generally referred to by reference numeral 10. The system 10 may include a machine 12 and may aggregate classifications of predictive operations of machine 12. The machine 12 may be any type of machine known in the earth-moving construction and agricultural industries such as, but not limited to, loaders, excavators, electric rope shovels, motor graders, mining equipment, agricultural equipment, and track-type tractors. The machine 12 may include one or more sensors 14, which detects data of the machine 12. The data detected by the one or more sensors 14 may be in the form of raw, on-board machine time series data of machine operations such as, but not limited to, dig, swing to truck, dump, swing to bank, propel, and idle for electric rope shovels and travel, load, carry, spread, push, rip, and idle for track-type tractors. For some machines, the raw, on-board machine time series data may be of micro-applications instead of operations. As an example, the data detected by the one or more sensors 14 for a motor grader may be in the form of raw, on-board machine time series data of machine micro-applications such as, but not limited to, travel, turnaround, ditch cutting, idle, finish blading, heavy blading, ripping, scarifying, roading, road maintenance, ditch building, ditch cleaning, snow plowing, snow removal, blade slope work, and side slope work.

The system 10 may include a variety of modules such as, but not limited to, a pre-processing module 16, an operation classifier module 18, an application resolver module 20, and a characterizer module 22.

The pre-processing module 16 may receive the raw, on-board machine time series data from the one or more sensors 14. One or more raw time series channels 24 may be associated with a respective sensor 14 to communicate the raw, on-board machine time series data to the pre-processing module 16. The pre-processing module 16 may process the raw, on-board machine time series data with a variety of functions such as, but not limited to, filtering to smooth the data, performing pulse-width demodulation, computing window-based statistics such as, for example, maximum or variance, computing sequential or combinatorial logic, calculating integrals or derivatives, performing a map lookup, and computing physics-based calculations such as, for example, drawbar force function.

The operation classifier module 18 may receive the processed, calculated data from the pre-processing module 16 and may also receive the raw, on-board machine time series data from the one or more sensors 14. One or more pre-processed channels 26 may communicate the processed, calculated data from the pre-processing module 16 to the operation classifier module 18. The operation classifier module 18 may process the data from the pre-processing module 16 and the raw, on-board machine time series data to predict the machine 12 operations. The operation classifier module 18 segments the processed, calculated data for a determined timestep at a discrete sample interval to produce a series of machine operation predictions expressed as a time series sequence. Alternatively, or in addition to, the series of machine operation predictions may be expressed as a series of operation-labeled time periods. The operation classifier module 18 may also provide an indication of certainty of the machine operation predictions. As non-limiting examples, the series of machine operation predictions expressed in time series sequence or as a series of operation-labeled time periods may represent machine operations such as, for example, dig, swing, dump, propel, idle, travel, load, carry, spread, push, rip, and any of the machine micro-applications exemplarily listed above.

The application resolver module 20 may receive the series of machine operation predictions, expressed as either a time series sequence or a series of operation-labeled time periods, from the operation classifier module 18. The application resolver module 20 processes the series of machine operation predictions to produce higher-level groupings of multiple machine operation predictions expressed into either cycles, if the machine 12 operation is cyclical, or into applications, if the machine 12 operation is non-cyclical. For example, as with electric rope shovels, the machine operation predictions of dig, swing to truck, dump, and swing to bank may be collectively resolved into the machine cycle of truck loading. As non-limiting examples, other cyclical machine operations may be haul cycle or dozing cycle. Non-limiting examples of non-cyclical machine operations may include, but not limited to, roading, heaving blading, and ditch cleaning.

The characterizer module 22 may also receive the series of machine operation predictions, expressed as either a time series sequence or a series of operation-labeled time periods, from the operation classifier module 18. The characterizer module 22 may also receive the raw, on-board machine time series data via one or more raw time series channels 24 and the processed, calculated data from the pre-processing module 16 via one or more pre-processed channels 26. The characterizer module 22 may process the series of machine operation predictions to provide severity measures, such as but not limited to strain, acceleration, and loads, and to provide performance measures, such as but not limited to gear, load factor, and speed. Such severity and performance measures may be calculated from the series of machine operation predictions, the raw, on-board machine time series data, and the processed, calculated data. Alternatively, such severity and performance measures may be calculated from the processed, calculated data and the raw, on-board machine time series data. Such severity and performance measures may be characterized, for later aggregation and analysis, into datasets such as, but not limited to, scalar statistics (minimum, maximum, and average), histograms, frequency spectrums, and the like. The characterizer module 22 may determine the content of such severity and performance characterizations by selecting and aggregating the raw, on-board machine time series data and the processed, calculated data according to machine operation predictions.

The system 10 may produce a variety of outputs. Such outputs may be determined from, but are not limited to, an application profile module 28, a reports module 30, and a composite work cycle module 32.

The application profile module 28 may receive either cycle or application data from the application resolver module 20 to aggregate into profile outputs by, as non-limiting examples, machine, model, fleet, geography, shift, and industry. The application profile module 28 may aggregate the profile outputs into percentage breakdown of what the machine 12 was doing for a particular selector.

The reports module 30 may receive the characterized severity and performance measures data from the characterizer module 22 and may receive either cycle or application data from the application resolver module 20. The reports module 30 may aggregate such received data into performance reports and productivity reports.

The composite work cycle module 32 may receive the characterized severity and performance measures data from the characterizer module 22. The composite work cycle module 32 may process at least such received data to inform a composite work cycle. A composite work cycle is defined as a standard list of events and severities that may be used in simulation or tests of a new machine design to prove the new machine design meets durability targets.

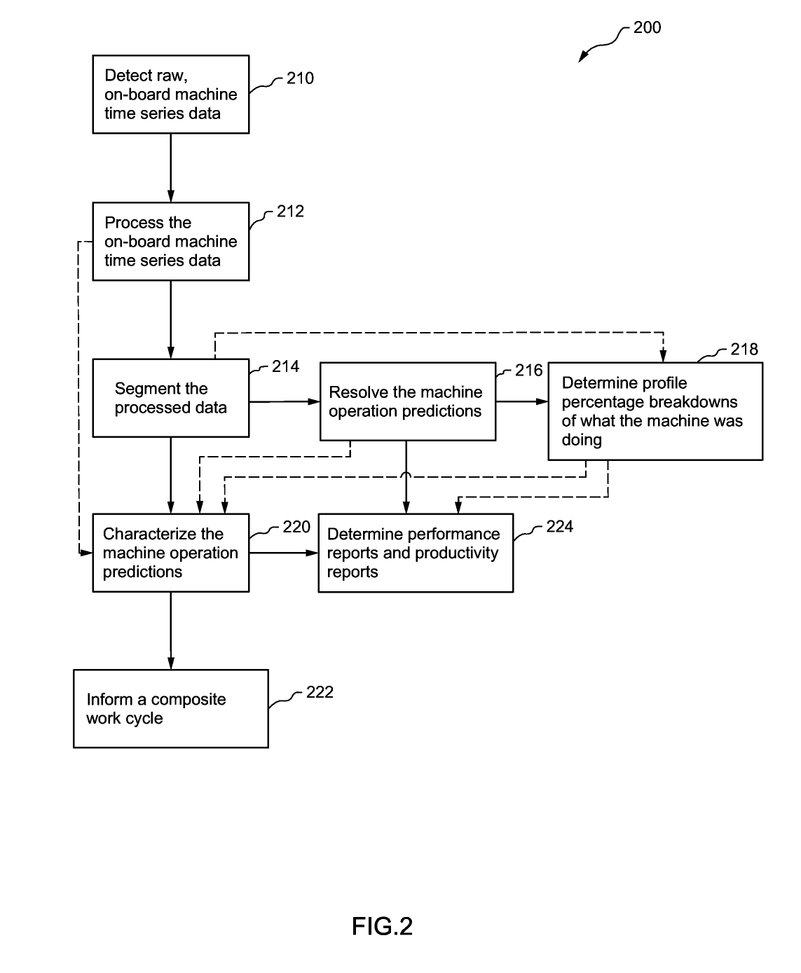

FIG. 2 illustrates a flowchart 200 of a sample sequence of steps which may be performed to process raw, on-board machine time series data into predictive machine operations expressed as time series sequences or periods for aggregation in order to estimate field severity, estimate performance characterization, generate performance and productivity reports, and resolve sequences of machine operations into cycles or applications. The sample sequence of steps may be performed using the system 10 of FIG. 1.

Starting at block 210, one or more sensors 14 may detect raw, on-board machine time series data from machine 12. Block 212 illustrates pre-processing the raw, on-board machine time series data. The pre-processing module 16 may receive the raw, on-board machine time series data from the one or more sensors 14 and process the time series data with a variety of functions into processed, calculated data. Such functions may include, but not limited to, filtering to smooth the data, performing pulse-width demodulation, computing window-based statistics such as, for example, maximum or variance, computing sequential or combinatorial logic, calculating integrals or derivatives, performing a map lookup, and computing physics-based calculations such as, for example, drawbar force function.

Another step, as shown in block 214, is segmenting, which involves the operation classifier module 18. The operation classifier module 18 may receive the processed, calculated data from the pre-processing module 16 and the raw, on-board machine time series data from the one or more sensors 14. The operation classifier module 18 may predict the machine 12 operations for each timestep at a discrete sample interval to produce a series of machine operation predictions as a time series sequence or a series of operation-labeled time periods. The operation classifier module 18 may also provide an indication of certainty of the machine operation predictions.

As illustrated in block 216, the application resolver module 20 may receive the series of machine operation predictions from the operation classifier module 18. The application resolver module 20 processes the machine operation predictions, which is either expressed as a time series sequence or a series of operation-labeled time periods, into cycles or applications. As shown in block 218, the application profile module 28 may receive the cycle or application data from the application resolver module 20 and may aggregate the data to profile the percentage breakdown of what the machine 12 was doing for a particular selector. Alternatively, as may be the case when the machine 12 is, for example, a motor grader, the application profile module 28 may directly aggregate the series of machine operation predications from the operation classifier module 18 to profile the percentage breakdown of what the machine 12 was doing for a particular selector.

Block 220 illustrates the step of the characterizer module 22 receiving the series of machine operation predictions from the operation classifier module 18. The characterizer module 22 may also receive the raw, on-board machine time series data from the one or more sensors 14 and the processed, calculated data from the pre-processing module 16, and may optionally receive the cycle or application data from the application resolver module 20 and the aggregated data from the application profile module 28. The characterizer module 22 may process any of such data into characterizations of severity measures and performance measures. Alternatively, as may be the case when the machine 12 is, for example, a track-type tractor, the characterizer module 22 may produce characterizations of severity measures and performance measures processed directly from the raw, on-board machine time series data from the one or more sensors 14 and the processed, calculated data from the pre-processing module 16. As shown in block 222, the composite work cycle module 32 may receive the characterized severity and performance measures data from the characterizer module 22. The composite work cycle module 32 may process at least the characterized severity and performance measures data to inform a composite work cycle. For example, the composite work cycle module 32 may process the characterized performance measure data to define initial and boundary conditions for informing the composite work cycle during simulation or testing. As another example, the composite work cycle module 32 may statistically process the characterized severity measure data to derive composite work cycle specifics.

At block 224, the reports module 30 may receive the characterized severity and performance measures data from the characterizer module 22 and may receive either cycle or application data from the application resolver module 20, and may optionally receive the aggregated data from the application profile module 28. The reports module 30 may aggregate such received data into performance reports and productivity reports.

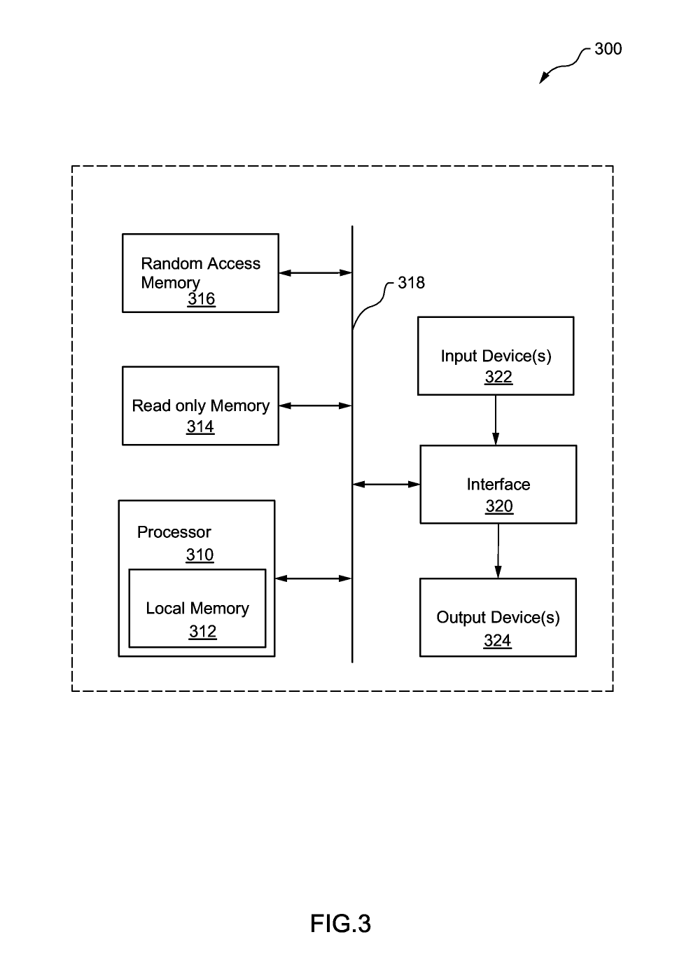

FIG. 3 is a block diagram of an example computer 300 capable of executing the systems and methods of the present disclosure. The computer 300 can be, for example, a server, a personal computer, or any other type of computing device.

The computer 300 of the instant example includes a processor 310. For example, the processor 310 can be implemented by one or more microprocessors or controllers from any desired family or manufacturer.

The processor 310 includes a local memory 312 and is in communication with a main memory including a read only memory 314 and a random access memory 316 via a bus 318. The random access memory 316 may be implemented by Synchronous Dynamic Random Access Memory (SDRAM), Dynamic Random Access Memory (DRAM), RAMBUS Dynamic Random Access Memory (RDRM) and/or any other type of random access memory device. The read only memory 314 may be implemented by a hard drive, flash memory and/or any other desired type of memory device.

The computer 300 also includes an interface circuit 320. The interface circuit 320 may be implemented by any type of interface standard, such as, for example, an Ethernet interface, a universal serial bus (USB), and/or a PCI express interface. One or more input devices 322 are connected to the interface circuit 320. The input device(s) 322 permit a user to enter data and commands into the processor 310. The input device(s) can be implemented by, for example, a keyboard, a mouse, a touchscreen, a track-pad, a trackball, isopoint and/or a voice recognition system.

One or more output devices 324 are also connected to the interface circuit 320. The output devices 324 can be implemented by, for example, display devices for associated data (e.g., a liquid crystal display, a cathode ray tube display (CRT), etc.).

The computer 300 may be used to execute machine readable instructions. For example, the computer 300 may execute machine readable instructions to perform the sample sequence of steps illustrated in flowchart 200 of FIG. 2. In such examples, the machine readable instructions comprise a program for execution by a processor such as the processor 310 shown in the example computer 300. The program may be embodied in software stored on a tangible computer readable medium such as a CD-ROM, a floppy disk, a hard drive, a digital versatile disk (DVD), a Blu-ray disk, or a memory associated with the processor 310, but the entire program and/or parts thereof could alternatively be executed by a device other than the processor 310 and/or embodied in firmware or dedicated hardware. Further, although the example programs are described with reference to the flowchart 200 illustrated in FIG. 2, many other methods of implementing embodiments of the present disclosure may alternatively be used. For example, the order of execution of the blocks may be changed, and/or some of the blocks described may be changed, eliminated, or combined.

While the present disclosure has shown and described details of exemplary embodiments, it will be understood by one skilled in the art that various changes in detail may be effected therein without departing from the spirit and scope of the disclosure as defined by claims supported by the written description and drawings. Further, where these exemplary embodiments (and other related derivations) are described with reference to a certain number of elements it will be understood that other exemplary embodiments may be practiced utilizing either less than or more than the certain number of elements.

### INDUSTRIAL APPLICABILITY

The disclosed systems and methods may be implemented using a computing device, such as the computer 300 of FIG. 3. The outputs of the application profile module 28, the reports module 30, and the composite work cycle module 32 may be presented by, for example, the output device(s) 324 of the computer 300.

Based on the foregoing, it can be seen that the present disclosure sets forth systems and methods for aggregating classifications of predictive operations of a machine 12. For example, the machine 12 may be an electric rope shovel. On site, the electric rope shovel may perform various operations such as, for example, digging from a bank of material, swinging its arm from the bank to a truck, dumping the material into the truck, and swinging back to the bank. The one or more sensors 14 may detect the raw, on-board machine time series data of such operations, which may be processed by the pre-processing module 16. The operation classifier module 18 may receive the processed time series data from the pre-processing module 16 and predict the particular machine operations, for example, of digging from a bank of material, swinging arm from bank to truck, dumping the material into the truck, and swinging back to the bank, expressed as time series sequences. The predictive time series sequences of these particular operations may be received by the application resolver module 20 to be further processed to express a truck-loading cycle (expressed as either a time series sequence or a series of operation-labeled time periods), for example, for this particular set of predictive time series sequences. As an example, the application profile module 28 may aggregate the cycle data from the application resolver module 20 to profile the percentage breakdown for a determined period of time in which the electric rope shovel has been used.

The predictive time series sequences may also be received by the characterizer module 22 to be characterized into severity measures and performance measures. As an example, the composite work cycle module 32 may process the severity measures and performance measures data to inform a composite work cycle.

Moreover, the reports module 30 may receive the characterized severity measures and performance measures data and the cycle data, and may optionally receive the aggregated data from the application profile module 28, for aggregating into performance reports and productivity reports.

Although the above example was described with particular reference to electric rope shovels, it is to be understood that such systems and methods may also apply, for example, to other machines known in the earth-moving construction and agricultural industries such as, but not limited to, loaders, excavators, motor graders, mining equipment, agricultural equipment, and track-type tractors.

As exemplified and described above, the teachings of this disclosure may be employed to easily process raw, on-board machine time series data into predictive machine operations expressed as time series sequences. Moreover, through the novel teachings set forth above, information about how a machine is being operated in the field may be aggregated to provide valuable insight into machine events and usage patterns. The aforementioned systems and methods may provide more accurate and reliable predictions and classifications of machine operations in order to estimate machine field severity and performance measures. Such estimates of machine field severity and performance measures may be aggregated into reports, which are particularly insightful for machine operators, overseers, manufacturers, design engineers, and analysts. Such reports may provide valuable insight for planning fleet usage, bidding on jobs, tracking current production levels, reducing product cost, improving product durability, and enhancing product features. Using the systems and methods described above also resolves the time series sequence of machine operation predictions into higher-level events such as cycles and applications in order to aggregate into percentage breakdowns for a particular category such as, for example, machine, model, fleet, geography, shift, and industry.

What is claimed is:

1. A system for aggregating classifications of predictive operations of a machine, the system comprising:
a processor;
one or more sensors in communication with the processor;
a pre-processing module associated with the one or more sensors and executed by the processor, the pre-processing module receiving on-board machine time series data from the one or more sensors;
an operation classifier module associated with the pre-processing module and executed by the processor, the operation classifier module receiving processed data from the pre-processing module;
an application resolver module associated with the operation classifier module and executed by the processor, the application resolver module receiving machine operation predictions from the operation classifier module;
a characterizer module associated with the operation classifier module and executed by the processor, the characterizer module receiving the machine operation predictions from the operation classifier module;
an application profile module associated with the application resolver module and executed by the processor, the application profile module receiving one of cycle data and application data from the application resolver module;
a reports module associated with the characterizer module and the application resolver module and executed by the processor, the reports module receiving severity and performance data from the characterizer module and receiving the one of cycle data and application data from the application resolver module; and
a composite work cycle module associated with the characterizer module and executed by the processor, the composite work cycle module receiving the severity and performance data from the characterizer module.

2. The system of claim 1, wherein the pre-processing module includes at least one function for processing the on-board machine time series data, the at least one function processes the on-board machine time series data by one of filtering, performing pulse-width demodulation, computing window-based statistics, calculating integrals, calculating derivatives, performing map lookup, and computing physics-based calculations.

3. The system of claim 1, wherein the machine operation predictions are expressed as time series sequences.

4. The system of claim 1, wherein the machine operation predictions are expressed as series of operation-labeled time periods.

5. The system of claim 1, wherein the machine is an earth-moving, construction, or agricultural machine and the machine operation predictions represent one of dig, swing, dump, propel, idle, travel, load, carry, spread, push, and rip.

6. The system of claim 1, wherein the operation classifier module receives the on-board machine time series data from the one or more sensors.

7. The system of claim 1, wherein the characterizer module receives the on-board machine time series data from the one or more sensors and receives the processed data from the pre-processing module.

8. A method for aggregating classifications of predictive operations of a machine, the method comprising:
receiving, from one or more sensors of the machine, on-board machine time series data using a computer processor;
processing the on-board machine time series data into processed data using the computer processor;
segmenting the processed data into machine operation predictions using the computer processor;
resolving the machine operation predictions into one of cycle data and application data using the computer processor;
characterizing the machine operation predictions into severity measures and performance measures using the computer processor;
determining profile percentage breakdowns of what the machine was doing using the computer processor;
determining performance reports and productivity reports using the computer processor; and
informing a composite work cycle using the computer processor.

9. The method of claim 8, wherein the step of determining profile percentage breakdowns includes aggregating the one of cycle data and application data.

10. The method of claim 8, wherein the step of determining profile percentage breakdowns includes aggregating the machine operation predictions.

11. The method of claim 8, wherein the step of determining performance reports and productivity reports includes aggregating the one of cycle data and application data, the severity measures, and the performance measures.

12. The method of claim 8, wherein the step of informing a composite work cycle includes processing the severity measures and performance measures.

13. The method of claim 8, wherein the machine operation predictions are expressed as one of time series sequences and series of operation-labeled time periods.

14. The method of claim 8, wherein the step of processing the on-board machine time series data into processed data includes one of filtering, performing pulse-width demodulation, computing window-based statistics, computing sequential logic, computing combinatorial logic, calculating integrals, calculating derivatives, performing a map lookup, and computing physics-based calculations.

15. The method of claim 8, wherein the machine operation predictions represent one of dig, swing, dump, propel, idle, travel, load, carry, spread, push, and rip.

16. A non-transitory, computer readable medium having thereon computer-executable instructions for aggregating classifications of predictive operations of a machine, the instructions comprising:
instructions for receiving, from one or more sensors of the machine, on-board machine time series data;
instructions for processing the on-board machine time series data into processed data;
instructions for segmenting the processed data into machine operation predictions;
instructions for resolving the machine operation predictions into one of cycle data and application data;
instructions for characterizing the machine operation predictions into severity measures and performance measures;
instructions for determining profile percentage breakdowns of what the machine was doing;
instructions for determining performance reports and productivity reports; and
instructions for informing a composite work cycle.

17. The non-transitory, computer readable medium having thereon computer-executable instructions of claim 16, wherein the instructions for determining profile percentage breakdowns includes aggregating the one of cycle data and application data.

18. The non-transitory, computer readable medium having thereon computer-executable instructions of claim 16, wherein the instructions for determining profile percentage breakdowns includes aggregating the machine operation predictions.

19. The non-transitory, computer readable medium having thereon computer-executable instructions of claim 16, wherein the instructions for determining performance reports and productivity reports includes aggregating the one of cycle data and application data, the severity measures, and the performance measures.

20. The non-transitory, computer readable medium having thereon computer-executable instructions of claim 16, wherein the instructions for informing a composite work cycle includes processing the severity measures and the performance measures.
